(19) United States
(12) Patent Application Publication
(10) Pub. No.: US 2021/0237493 A1
(43) Pub. Date: Aug. 5, 2021

(54) PRINTING APPARATUS

(71) Applicant: SEIKO EPSON CORPORATION, Tokyo (JP)

(72) Inventor: Kenji YANAGISHITA, Matsumoto-shi (JP)

(21) Appl. No.: 17/163,977

(22) Filed: Feb. 1, 2021

(30) Foreign Application Priority Data
Jan. 31, 2020 (JP) 2020-014614

(51) Int. Cl. B41J 25/308

(52) U.S. Cl. CPC B41J 25/3082

(57) ABSTRACT

A printing apparatus includes a head configured to project a plurality of pins to perform printing on a printing medium, a carriage mounted with a head and configured to move, a roller mounted on the carriage and capable of coming into contact with the printing medium, a platen provided in a position opposed to the head and capable of moving in each of a direction in which the platen approaches the head and a direction in which the platen moves away from the head, and a pressing mechanism configured to press the platen toward the head. The pressing mechanism includes an elastic section configured to press the platen toward the head with an elastic force and a moving section configured to move the elastic section in each of a direction in which the elastic force of the elastic section increases and a direction in which the elastic force of the elastic section decreases.

The present application is based on, and claims priority from JP Application Serial Number 2020-014614, filed Jan. 31, 2020, the disclosure of which is hereby incorporated by reference herein in its entirety.

### BACKGROUND

### 1. Technical Field

The present disclosure relates to a printing apparatus.

### 2. Related Art

Printing apparatuses that perform printing on printing media such as bankbooks have been studied and developed.

Concerning the printing apparatuses, there has been known a printing apparatus including a head configured to project a plurality of pins to perform printing on a printing medium, a carriage mounted with the head and configured to move, a roller mounted on the carriage and capable of coming into contact with the printing medium, a platen provided in a position opposed to the head and capable of moving in each of a direction in which the platen approaches the head and a direction in which the platen moves away from the head, and a pressing mechanism configured to press the platen toward the head (see JP-A-2003-159851 (Patent Literature 1)).

The pressing mechanism of the printing apparatus described in Patent Literature 1 presses the platen toward the head with an elastic force of an elastic member such as a spring. Accordingly, in the printing apparatus, as the printing medium is thicker, a bound of the platen due to the contact of the head with the printing medium more easily occurs. In the printing apparatus, when the platen bounds, the distance between the printing medium and the head increases and the quality of the printing on the printing medium by the head is sometimes deteriorated. As a method of avoiding this problem, a method of replacing the elastic member with an elastic member having a larger elastic force is conceivable. However, when the elastic force is increased by such a method, in the printing apparatus, a conveyance load of the printing medium increases irrespective of the thickness of the printing medium. As a result, in the printing apparatus, for example, as the printing medium is thinner, deformation of the printing medium more easily occurs because of the increased conveyance load. In the printing apparatus, this problem is considered to be a problem that occurs because the elastic force of the elastic member cannot be adjusted according to the thickness of the printing medium.

In the printing apparatus described in Patent Literature 1, even when the elastic force of the elastic member is sufficiently large, in some case, a driving frequency of the pins projecting from the head and an eigenfrequency of the platen resonate and the platen bounds. In the printing apparatus, the quality of the printing on the printing medium by the head is sometimes deteriorated in such a case as well. This problem is also considered to be a problem that occurs because the elastic force of the elastic member cannot be adjusted according to the thickness of the printing medium.

### SUMMARY

An aspect of the present disclosure is directed to a printing apparatus including: a head configured to project a plurality of pins (wires) to perform printing on a printing medium; a carriage mounted with a head and configured to move; a roller mounted on the carriage and capable of coming into contact with the printing medium; a platen provided in a position opposed to the head and capable of moving in each of a direction in which the platen approaches the head and a direction in which the platen moves away from the head; and a pressing mechanism configured to press the platen toward the head. The pressing mechanism includes: an elastic section configured to press the platen toward the head with an elastic force; and a moving section configured to move the elastic section in each of a direction in which the elastic force of the elastic section increases and a direction in which the elastic force of the elastic section decreases.

### BRIEF DESCRIPTION OF THE DRAWINGS

FIG. 1 is a perspective view showing an example of the exterior of a printing apparatus according to an embodiment.

FIG. 2 is a perspective view showing an example of a printing apparatus main body.

FIG. 3 is a perspective view showing an example of a main part configuration of the printing apparatus main body.

FIG. 4 is a side sectional view of the printing apparatus shown in FIG. 1.

FIG. 5 is a perspective view showing an example of a head detached from a carriage.

FIG. 6 is a main part exploded perspective view showing an example of the configuration and an attached state of a platen.

FIG. 7 is a main part enlarged perspective view showing an example of the attached state of the platen.

FIG. 8 is a main part enlarged front view showing the attached state of the platen shown in FIG. 7.

### DESCRIPTION OF EXEMPLARY EMBODIMENTS

### Embodiment

An embodiment of the present disclosure is explained below with reference to the drawings.

In the following explanation, directions in the figures are explained using a three-dimensional coordinate system TC. The three-dimensional coordinate system TC is a three-dimensional orthogonal coordinate system indicating the directions in the figures in which the three-dimensional coordinate system TC is drawn. In the following explanation, for convenience of explanation, an X axis in the three-dimensional coordinate system TC is simply referred to as X axis, a Y axis in the three-dimensional coordinate system TC is simply referred to as Y axis, and a Z axis in the three-dimensional coordinate system TC is simply referred to as Z axis.

In the following explanation, as an example, a negative direction of the Z axis and the gravity direction coincide. In the following explanation, for convenience of explanation, a positive direction of the Z axis is referred to as upward direction or simply referred to as upward, the negative direction of the Z axis is referred to as downward direction or simply referred to as downward, a positive direction of the Y axis is referred to as left direction or simply referred to as left, a negative direction of the Y axis is referred to as right direction or simply referred to as right, a positive direction of the X axis is referred to as forward direction or simply referred to as forward, and a negative direction of the X axis is referred to as rearward direction or simply referred to as rearward.

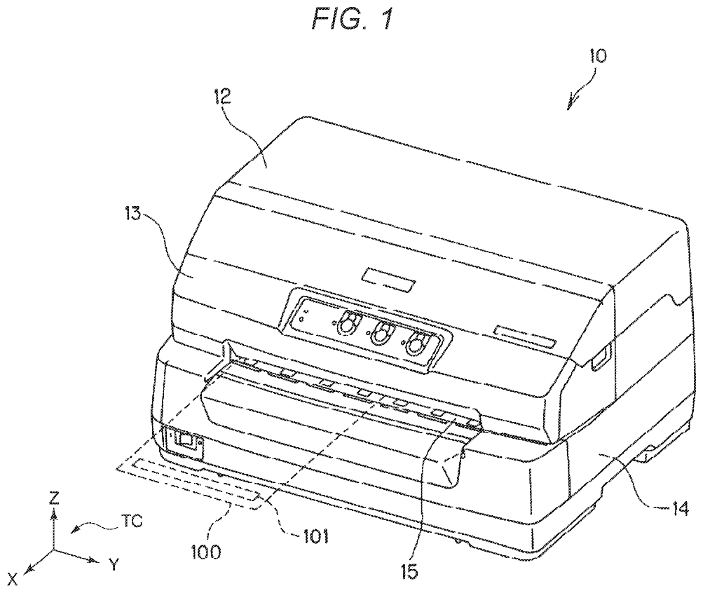

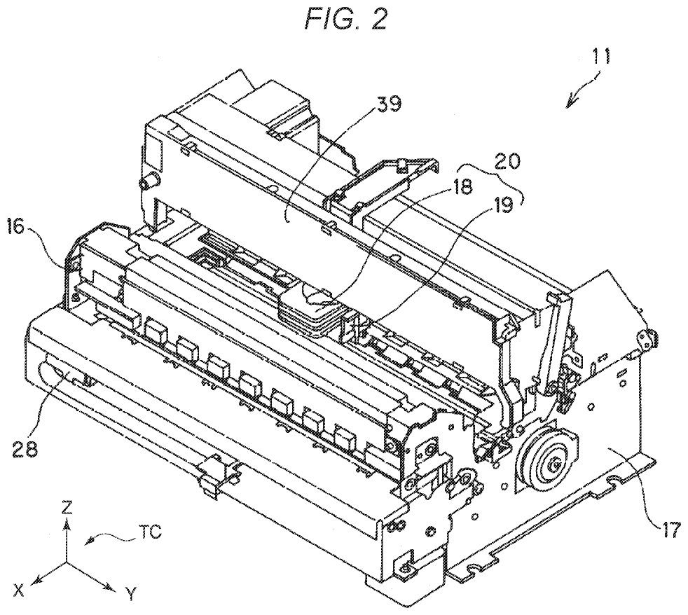

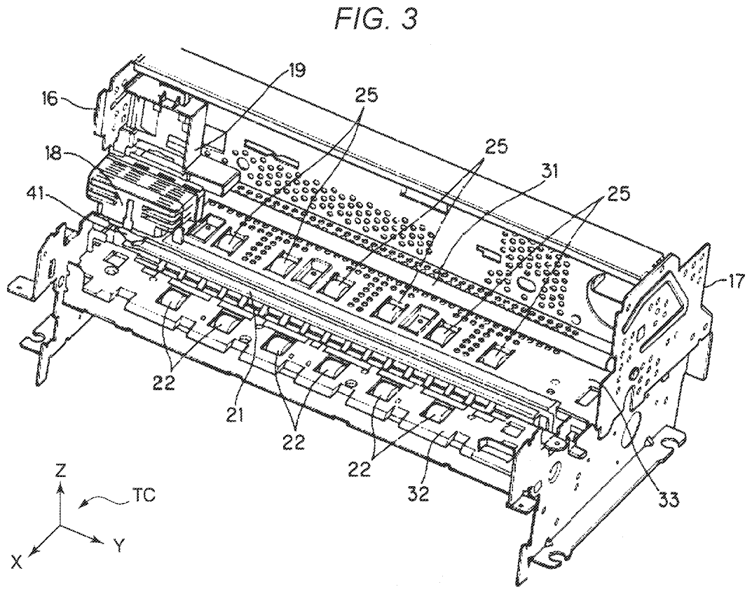

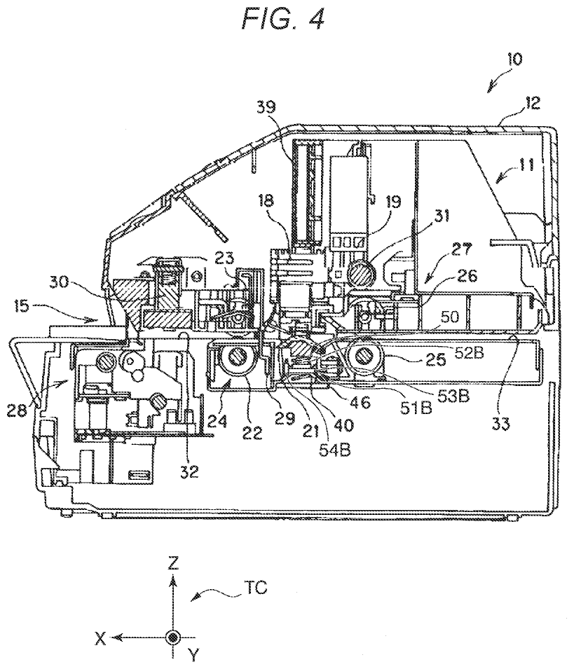

FIG. 1 is a perspective view showing an example of the exterior of a printing apparatus 10 according to the embodiment. FIG. 2 is a perspective view showing an example of a printing apparatus main body 11. FIG. 3 is a perspective view showing an example of a main part configuration of the printing apparatus main body 11. FIG. 4 is a side sectional view of the printing apparatus 10 shown in FIG. 1.

The printing apparatus 10 shown in FIGS. 1 to 4 is a dot impact printer. The printing apparatus 10 includes a head 18 that projects a plurality of pins (wires) 44 to print an image such as a character on a printing medium 100. That is, the head 18 includes the plurality of pins 44. In FIGS. 2 to 4 in which the head 18 is shown, the plurality of pins 44 are not shown in order to simplify the figures.

The printing apparatus 10 projects a part or all of the plurality of pins 44 included in the head 18 and presses the projected one or more pins 44 against the printing medium 100 via an ink ribbon. Consequently, the printing apparatus 10 forms dots on the printing medium 100 and prints an image such as a character on the printing medium 100.

The printing medium 100 is a sheet on which an image such as a character is printed. The printing medium 100 may be a cut sheet cut to a predetermined length or may be a continuous sheet formed by connecting a plurality of pieces of paper. The cut sheet may be plain paper such as cut-form paper or cut-form copy paper, may be a bankbook, a postcard, an envelope, or the like, or may be other sheets cut to predetermined lengths. The continuous sheet is, for example, continuous paper or continuous copy paper. In the following explanation, as an example, the printing medium 100 is a bankbook. In this case, the printing medium 100 is formed by binding a plurality of pieces of recording paper. A magnetic stripe 101 is provided on a surface, which is a bottom surface when a recording surface of the recording paper is opened.

The printing apparatus 10 includes a printing apparatus main body 11, an upper cover 12, which is an exterior body that covers the printing apparatus main body 11, an upper housing 13, and a lower housing 14. A manual insertion port 15 is opened on front surfaces of the upper housing 13 and the lower housing 14.

The printing apparatus main body 11 includes a not-shown main body frame including a right side frame 16 and a left side frame 17. The printing apparatus main body 11 includes a printing mechanism section 20 including the head 18 and a carriage 19. The printing apparatus main body 11 includes a platen 21 provided in a position opposed to the head 18 and capable of moving in each of a direction in which the platen 21 approaches the head 18 and a direction in which the platen 21 moves away from the head 18. In an example shown in FIGS. 1 to 4, the direction in which the platen 21 approaches the head 18 coincides with the upward direction and the direction in which the platen 21 moves away from the head 18 coincides with the downward direction.

The printing apparatus main body 11 includes a first conveying mechanism section 24 including first conveying rollers 22 and second conveying rollers 23. The printing apparatus main body 11 includes a second conveying mechanism section 27 including third conveying rollers 25 and fourth conveying rollers 26. The printing apparatus main body 11 includes a magnetic-data reading section 28 that performs reading and writing of magnetic information of the magnetic stripe 101 provided in the printing medium 100. The printing apparatus main body 11 includes an alignment plate 29 capable of advancing to and retracting from a conveyance route of the printing medium 100. The printing apparatus main body 11 includes a pressing section 30 that presses a lift of the printing medium 100 from above during reading of magnetic information from and writing of magnetic information in the magnetic stripe 101 by the magnetic-data reading section 28.

A carriage shaft 31 is laid between the right side frame 16 and the left side frame 17 included in the main body frame. A front printing medium guide 32 and a rear printing medium guide 33 having a flat surface shape are fixed and provided between the right side frame 16 and the left side frame 17. The platen 21 having a plane shape is disposed between the front printing medium guide 32 and the rear printing medium guide 33.

The first conveying mechanism section 24 is disposed on the front side of the printing apparatus main body 11 with respect to the platen 21. The second conveying mechanism section 27 is disposed on a rear side of the printing apparatus main body 11 with respect to the platen 21. Further, the first conveying rollers 22 and the second conveying rollers 23 are respectively disposed in the up-down direction to form pairs. The third conveying rollers 25 and the fourth conveying rollers 26 are also disposed in the up-down direction to form pairs. The first conveying rollers 22 are disposed below the front printing medium guide 32 together with the platen 21. The third conveying rollers 25 are disposed below the rear printing medium guide 33 together with the platen 21. The second conveying rollers 23 are disposed above the front printing medium guide 32. The fourth conveying rollers 26 are disposed above the rear printing medium guide 33.

The first conveying rollers 22 and the third conveying rollers 25 are driving rollers driven to rotate by a not-shown conveying motor and a not-shown driving wheel train section. The second conveying rollers 23 and the fourth conveying rollers 26 are driven rollers respectively spring-urged by a predetermined pressing force respectively to the first conveying rollers 22 side and the third conveying roller 25 side. Consequently, the first conveying rollers 22 and the second conveying rollers 23 are driven to rotate in opposite directions from each other and the third conveying rollers 25 and the fourth conveying rollers 26 are driven to rotate in opposite directions from each other.

The printing medium 100 is conveyed in a direction orthogonal to a scanning direction of the carriage 19 by the operation of the first conveying mechanism section 24 and the second conveying mechanism section 27.

The carriage 19 is slidably inserted through the carriage shaft 31. The carriage 19 is mounted with the head 18. The carriage 19 is coupled to a not-shown timing belt. The timing belt is laid over a not-shown belt driving pulley driven by a not-shown carriage driving motor. The carriage 19 is caused to travel (scan) by regular rotation or reverse rotation of the carriage driving motor in a main scanning direction coinciding with the axial direction of the carriage shaft 31 and the longitudinal direction of the platen 21 in a range between the right side frame 16 and the left side frame 17.

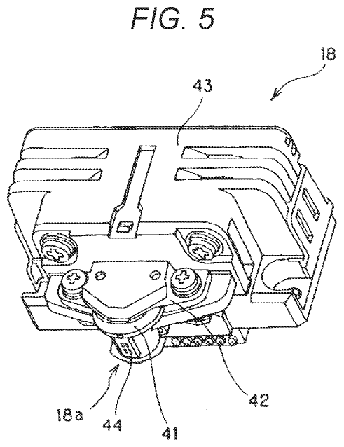

FIG. 5 is a perspective view showing an example of the head 18 detached from the carriage 19.

As shown in FIG. 5, the head 18 is configured by connecting a nose section 42 to a not-shown head main body and disposing a radiator 43 on the outer side of the head main body. The distal end of the nose section 42 is a head distal end face 18a from which the plurality of pins 44 project. A not-shown ink ribbon is located forward in a projecting direction of the pins 44. The ink ribbon is folded and stored in a ribbon cartridge 39 inserted between the right side frame 16 and the left side frame 17.

The head 18 projects the pins 44 from the head distal end face 18a and hits the pins 44 against the ink ribbon while the head 18 is caused to travel in the main scanning direction together with the carriage 19. Consequently, the head 18 can cause ink of the ink ribbon to adhere to the printing medium 100 conveyed between the platen 21 and the head 18 and print an image such as a character on the printing medium 100.

Although not shown, the head 18 includes an electromagnetic coil fit in a core formed in a frame of the head main body. When driving the pins 44, the head 18 energizes the electromagnetic coil and drives the pins 44 via a pin lever with a magnetic force of the electromagnetic coil. That is, the head 18 projects the pins 44 toward the platen 21 by energizing the electromagnetic coil. A projecting force of the pins 44 is determined by the width of the energization to the electromagnetic coil. That is, the projecting force of the pins 44 is larger as the width of the energization to the electromagnetic coil is set larger and is smaller as the width of the energization to the electromagnetic coil is set smaller.

In the head 18, a platen gap roller 41 is disposed on a side of the head distal end face 18a in order to keep a constant gap between a printing surface of the printing medium 100 conveyed on the platen 21 and the head distal end face 18a opposed to the printing medium 100. In other words, the platen gap roller 41 is a roller mounted on the carriage 19 and capable of coming into contact with the printing medium 100. The printing surface of the printing medium 100 means a surface on which an image is printed among surfaces of the printing medium 100.

The platen gap roller 41 is a roller that extends a predetermined distance from the head distal end face 18a such that the distance between the head 18 and the platen 21, that is, the gap between the head distal end face 18a and the platen 21 is not smaller than a predetermined distance irrespective of presence or absence of the printing medium 100 on the platen 21. Since the platen gap roller 41 comes into contact with the platen 21 or the printing medium 100, the distance between the head distal end face 18a and the platen 21 is not smaller than the predetermined distance. The platen gap roller 41 may be described as gap adjusting section. The gap adjusting section is not limited to the platen gap roller 41 if the gap adjusting section is configured to adjust the distance between the head 18 and the platen 21.

The platen gap roller 41 is capable of rotating around a rotation axis of the platen gap roller 41 provided in the head 18 and rotates while moving on the platen 21 according to movement of the carriage 19 along the carriage shaft 31. Accordingly, the platen gap roller 41 can cause the carriage 19 to travel (scan) while remaining in contact with the printing medium 100 on the platen 21 or the platen 21.

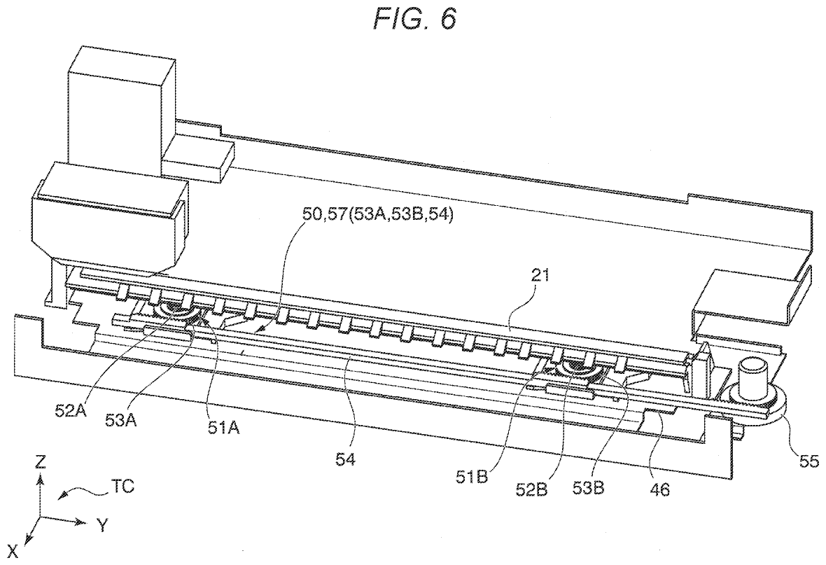

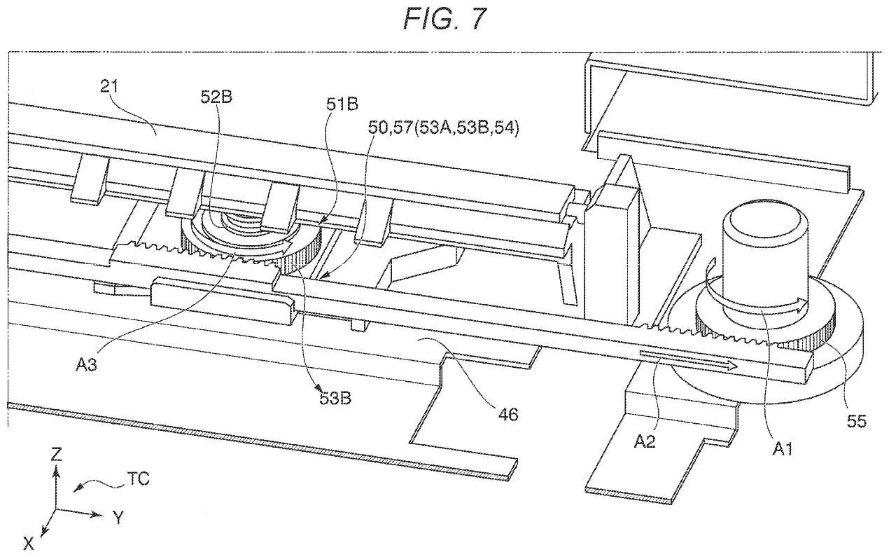

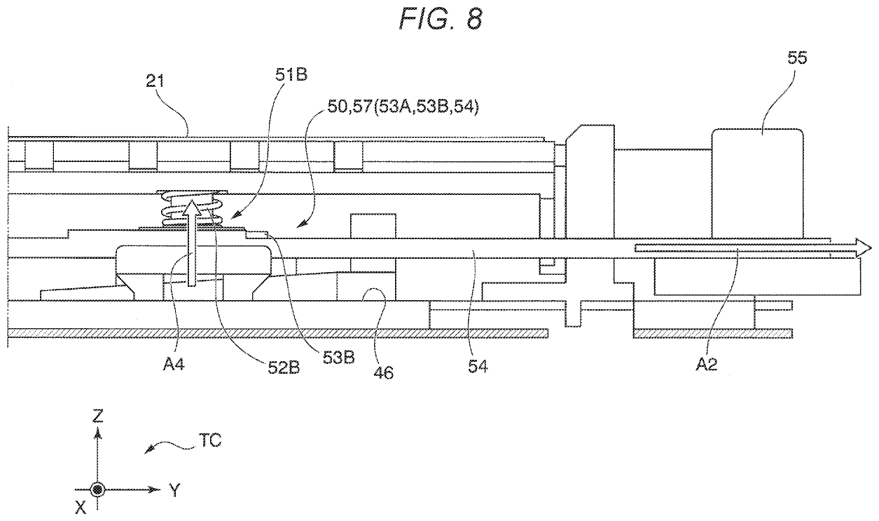

FIG. 6 is a main part exploded perspective view showing an example of the configuration and an attached state of the platen 21. FIG. 7 is a main part enlarged perspective view showing an example of the attached state of the platen 21. FIG. 8 is a main part enlarged front view showing the attached state of the platen 21 shown in FIG. 7.

The platen 21 is a flat platen extending in a traveling direction of the carriage 19 and formed in a plane shape. The platen 21 is supported via a pressing mechanism 50 with respect to a base plate 46 disposed below the platen 21. In FIGS. 2 and 3, the configuration and the attached state of the platen 21 including the pressing mechanism 50 are not shown in order to simplify the figures.

The pressing mechanism 50 includes one or more supporting sections 51 provided on the base plate 46 and supports the platen 21 upward with the one or more supporting sections 51. In an example shown in FIGS. 6 to 8, the pressing mechanism 50 includes two supporting sections 51 arranged on the left and the right along the platen 21 when the pressing mechanism 50 is viewed downward and supports the platen 21 upward with respect to the base plate 46 with the two supporting sections 51. In FIGS. 6 to 8, of the two supporting sections 51, the supporting section 51 located on the right side is shown as a supporting section 51A and the supporting section 51 located on the left side is shown as a supporting section 51B. In the following explanation, for convenience of explanation, the supporting section 51A and the supporting section 51B included in the pressing mechanism 50 are collectively referred to as the supporting sections 51 included in the pressing mechanism 50 and explained as long as it is unnecessary to distinguish the supporting section 51A and the supporting section 51B.

The supporting sections 51 included in the pressing mechanism 50 include elastic sections 52 that press the platen 21 toward the head 18 with an elastic force and gears 53 that are in contact with the elastic sections 52. In FIGS. 6 to 8, the elastic section 52 included in the supporting section 51A is shown as an elastic section 52A, the gear 53 included in the supporting section 51A is shown as a gear 53A, the elastic section 52 included in the supporting section 51B is shown as an elastic section 52B, and the gear 53 included in the supporting section 51B is shown as a gear 53B.

The elastic sections 52 are, for example, coil springs. The elastic sections 52 may be any member such as a leaf spring if the member is a member capable of pressing the platen 21 toward the head 18 with an elastic force.

The gears 53 are gears that move in a predetermined direction according to rotation. More specifically, the gears 53 are gears that regularly or reversely rotate to thereby move the elastic sections 52 in each of a direction in which the elastic force of the elastic sections 52 increases and a direction in which the elastic force of the elastic sections 52 decreases. The gears 53 are provided on the base plate 46 to be capable of rotating around rotation axes of the gears 53. In the example shown in FIGS. 6 to 8, the gears 53 are provided on the base plate 46 via spacers. However, the gears 53 may be provided on the base plate 46 not via the spacers. Accordingly, in the example, such spacers between the gears 53 and the base plate 46 are not shown.

The pressing mechanism 50 includes a transmitting mechanism 54 that rotates the gears 53 of the supporting sections 51 included in the pressing mechanism 50. More specifically, the transmitting mechanism 54 is a mechanism that transmits a driving force for rotating the gears 53 of the supporting sections 51 included in the pressing mechanism 50 to the gears 53 of the supporting sections 51 included in the pressing mechanism 50. In the example shown in FIGS. 6 to 8, the transmitting mechanism 54 is a rack that rotates the gears 53, which are pinions. Instead of the rack, the transmitting mechanism 54 may be any mechanism if the mechanism is a mechanism capable of transmitting the driving force to the gears 53 of the supporting sections 51 included in the pressing mechanism 50. In the example, the transmitting mechanism 54 is meshed with a gear 55 provided on the left side of the platen 21. That is, the transmitting mechanism 54 rotates the gears 53 by moving in the left direction or the right direction according to rotation of the gear 55. In the following explanation, when the transmitting mechanism 54 moves in the left direction, the gears 53 move the elastic sections 52 in a direction in which the elastic force of the elastic sections 52 increases and, when the transmitting mechanism 54 moves in the right direction, the gears 53 move the elastic sections 52 in a direction in which the elastic force of the elastic sections 52 decreases. In this case, when the gear 55 rotates in a direction indicated by an arrow A1, the transmitting mechanism 54 moves in the left direction indicated by an arrow A2. The gears 53 rotate in a direction indicated by an arrow A3 according to the movement of the transmitting mechanism 54 in the left direction. As a result, the gears 53 move the elastic sections 52 in a direction indicated by an arrow A4, that is, a direction in which the elastic force of the elastic sections 52 increases.

The transmitting mechanism 54 may include the gear 55 or may not include the gear 55.

In this way, the gears 53 and the transmitting mechanism 54 configure a moving section 57 that moves the elastic sections 52 in each of the direction in which the elastic force of the elastic sections 52 increases and the direction in which the elastic force of the elastic sections 52 decreases. In the example shown in FIGS. 6 to 8, the moving section 57 includes the gear 53A, the gear 53B, and the transmitting mechanism 54. The moving section 57 may be described as changing a state of the elastic sections 52. For example, a state in which the elastic force of the elastic sections 52 is a first elastic force may be described as a first state and a state in which the elastic force of the elastic sections 52 is a second elastic force weaker than the first elastic force may be set as a second state. The moving section 57 changes the state of the elastic sections 52 to each of the first state and the second state. The first elastic force may be described as stronger than the second elastic force. The first state may be described as a state in which the elastic sections 52 contract. The second state may be described as a state in which the elastic sections 52 extend.

The gear 55 may be configured to be rotated by a hand of a user of the printing apparatus 10. In this case, an operation section with which the user is capable of rotating the gear 55 from the outer side of the printing apparatus 10 is included in the printing apparatus 10. Consequently, the user can adjust, according to a type, thickness, and the like of the printing medium 100 on which an image is printed by the printing apparatus 10, force for pressing the platen 21 toward the head 18.

The gear 55 may be configured to be rotated by an actuator such as a motor driven by a control section included in the printing apparatus 10. The control section is, for example, a CPU (Central Processing Unit) but may be another processor such as an FPGA (Field Programmable Gate Array). In this case, the control section rotates the gear 55 with the actuator according to, for example, a type and thickness of the printing medium 100 and moves the transmitting mechanism 54 to rotate the gears 53. In other words, the control section rotates the gears 53 with the transmitting mechanism 54 according to the type of the printing medium 100. Consequently, the printing apparatus 10 can also adjust, according to the type, the thickness, and the like of the printing medium 100 on which an image is printed by the printing apparatus 10, the force for pressing the platen 21 toward the head 18. The control section may be configured to receive information indicating the type, the thickness, and the like according to operation from the user, may be configured to receive the information from another apparatus, or may be configured to detect the type, the thickness, and the like with various sensors.

When the printing apparatus 10 includes the control section as explained above, the printing apparatus 10 may include a sensor that detects the thickness of a portion located in a position immediately before being placed on the platen 21 in a portion of the printing medium 100 during printing on the printing medium 100 by the head 18. In this case, during the printing on the printing medium 100 by the head 18, the control section rotates the gear 55 with the actuator according to the thickness of the printing medium 100 and moves the transmitting mechanism 54 to rotate the gears 53. In other words, in this case, the control section rotates the gears 53 with the transmitting mechanism 54 according to the thickness of the printing medium 100 during the printing on the printing medium 100 by the head 18. Consequently, even when the printing apparatus 10 prints an image on the printing medium 100, the thickness of which is not fixed, the printing apparatus 10 can adjust, according to the thickness of the printing medium 100, the force for pressing the platen 21 toward the head 18. As a result, even in this case, the printing apparatus 10 can suppress the deterioration of the quality of the printing.

In the printing apparatus 10, a driving frequency of each of the plurality of pins 44 and eigenfrequencies of the elastic sections 52, the pressing mechanism 50 including the elastic sections 52, and the platen 21 that is in contact with the elastic sections 52 are set not to resonate. Consequently, the printing apparatus 10 can more surely suppress the deterioration of the quality of the printing on the printing medium 100 by the head 18 because the driving frequency of the pins 44 projecting from the head 18 and the eigenfrequency of the platen 21 resonate.

The moving section 57 explained above may be another member such as a linear actuator capable of moving the elastic sections 52 in each of the direction in which the elastic force of the elastic sections 52 increases and the direction in which the elastic force of the elastic sections 52 decreases. When the moving section 57 is the linear actuator, the linear actuator is controlled by, for example, the control section explained above.

As explained above, the printing apparatus according to the embodiment includes a head configured to project a plurality of pins to perform printing on a printing medium, a carriage mounted with a head and configured to move, a roller mounted on the carriage and capable of coming into contact with the printing medium, a platen provided in a position opposed to the head and capable of moving in each of a direction in which the platen approaches the head and a direction in which the platen moves away from the head, and a pressing mechanism configured to press the platen toward the head. The pressing mechanism includes an elastic section configured to press the platen toward the head with an elastic force and a moving section configured to move the elastic section in each of a direction in which the elastic force of the elastic section increases and a direction in which the elastic force of the elastic section decreases. Consequently, the printing apparatus can easily adjust force for pressing the platen toward the head according to the printing medium. In the example explained above, the printing apparatus 10 is an example of the printing apparatus, the pins 44 are an example of the pins, the printing medium 100 is an example of the printing medium, the head 18 is an example of the head, the carriage 19 is an example of the carriage, the platen gap roller 41 is an example of the roller, the platen 21 is an example of the platen, the pressing mechanism 50 is an example of the pressing mechanism, the elastic sections 52 are an example of the elastic section, and the moving section 57 is an example of the moving section.

In the printing apparatus, the moving section may include a gear that is in contact with the elastic section and a transmitting mechanism configured to rotate the gear. The gear may move in a predetermined direction according to the rotation. In the example explained above, the gears 53 are an example of the gear, the transmitting mechanism 54 is an example of the transmitting mechanism, and each of the direction in which the elastic force of the elastic sections 52 increases and the direction in which the elastic force of the elastic sections 52 decreases is an example of the predetermined direction.

The printing apparatus may include a control section. The control section may rotate the gear with the transmitting mechanism according to a type of the printing medium.

In the printing apparatus, the control section may rotate the gear with the transmitting mechanism according to thickness of the printing medium during the printing on the printing medium by the head.

In the printing apparatus, a driving frequency of each of the plurality of pins and eigenfrequencies of the elastic section, the pressing mechanism including the elastic section, and the platen that is in contact with the elastic section may be set not to resonate.

The embodiment of the present disclosure is explained in detail above with reference to the drawings. However, a specific configuration is not limited to this embodiment and may be, for example, changed, substituted, or deleted without departing from the gist of the present disclosure.

A program for realizing a function of any component in the apparatus explained above may be recorded in a computer-readable recording medium and read and executed by a computer system. The apparatus is, for example, the printing apparatus 10. The “computer system” includes an OS (Operating System) and hardware such as peripheral devices. The “computer-readable recording medium” means a portable medium such as a flexible disk, a magneto-optical disk, a ROM, or a CD (Compact Disk)-ROM or a storage device such as a hard disk incorporated in the computer system. Further, the “computer-readable recording medium” includes a recording medium that holds the program for a fixed time like a volatile memory on the inside of a computer system functioning as a server or a client when the program is transmitted via a network such as the Internet or a communication line such as a telephone line.

The program may be transmitted from the computer system storing the program in the storage device or the like to other computer systems via a transmission medium or a transmission wave in the transmission medium. The “transmission medium” that transmits the program means a medium having a function of transmitting information like a network such as the Internet or a communication line such as a telephone line.

The program may be a program for realizing a part of the functions explained above. Further, the program may be a program that can realize the functions explained above in a combination with a program already recorded in the computer system, a so-called differential file or a differential program.

What is claimed is:

1. A printing apparatus comprising:
a head configured to project a plurality of pins to perform printing on a printing medium;
a carriage mounted with a head and configured to move;
a roller mounted on the carriage and configured to come into contact with the printing medium;
a platen provided in a position opposed to the head and configured to move in each of a direction in which the platen approaches the head and a direction in which the platen moves away from the head; and
a pressing mechanism configured to press the platen toward the head, wherein
the pressing mechanism includes:
an elastic section configured to press the platen toward the head with an elastic force; and
a moving section configured to move the elastic section in each of a direction in which the elastic force of the elastic section increases and a direction in which the elastic force of the elastic section decreases.

2. The printing apparatus according to claim 1, wherein
the moving section includes:
a gear that is in contact with the elastic section: and
a transmitting mechanism configured to rotate the gear, and
the gear moves in a predetermined direction according to the rotation.

3. The printing apparatus according to claim 2, further comprising a control section, wherein
the control section rotates the gear with the transmitting mechanism according to a type of the printing medium.

4. The printing apparatus according to claim 3, wherein the control section rotates the gear with the transmitting mechanism according to thickness of the printing medium during the printing on the printing medium by the head.

5. The printing apparatus according to claim 1, wherein a driving frequency of each of the plurality of pins and eigenfrequencies of the elastic section, the pressing mechanism including the elastic section, and the platen that is in contact with the elastic section are set not to resonate.

6. A printing apparatus comprising:
a head configured to project a plurality of pins to perform printing on a printing medium;
a platen provided in a position opposed to the head and configured to move in each of a direction in which the platen approaches the head and a direction in which the platen moves away from the head;
a gap adjusting section configured to adjust a distance between the head and the platen; and
a pressing mechanism including an elastic section configured to press, with an elastic force, the platen in a direction in which the platen approaches the head and a moving section configured to change a state of the elastic section to each of a first state in which the elastic force of the elastic section is a first elastic force and a second state in which the elastic force of the elastic section is a second elastic force weaker than the first elastic force.
